(19) United States
(12) Patent Application Publication
(10) Pub. No.: US 2020/0175520 A1
(43) Pub. Date: Jun. 4, 2020

(54) SYSTEMS AND METHODS FOR CONDUCTING NEURAL PROCESS-BASED TRANSACTIONS

(71) Applicant: JPMorgan Chase Bank, N.A., New York, NY (US)

(72) Inventors: Adrian J. MCKAY, Chichester (GB); Ryan Andrew SCHLOSSER, New York, NY (US); Mary Estelle WARNER, Chicago, IL (US); Erin MONAHAN, New York, NY (US)

(21) Appl. No.: 15/244,636

(22) Filed: Aug. 23, 2016

(51) Int. Cl. G06Q 20/40

(52) U.S. Cl. CPC G06Q 20/40145; G06Q 20/405

(57) ABSTRACT

Systems and methods for conducting neural process-based transactions are disclosed. According to one embodiment, a system for conducting a neural-based transaction may include a brainwave sensing device that detects brainwave activity for a user; a point of transaction comprising a point of transaction computer processor in communication with the brainwave sensing device; and a back end comprising a back end computer processor that is in communication with the point of transaction. The brainwave sensing device may sense brainwave activity for the user. The back end may receive the brainwave activity sensed by the brainwave sensing device, and may identify an action associated with the brainwave activity. The back end may then communicate the activity to the point of transaction, which may execute the action.

### BACKGROUND OF THE INVENTION

### 1. Field of the Invention

The present disclosure generally relates to systems and methods for conducting neural process-based transactions.

### 2. Description of the Related Art

Identity authentication is a foundation element of the financial world. Without effective methods of ensuring that the “right” person is doing the “right” thing, there would be financial anarchy. Although traditional methods of authentication are generally reliable, the digital age has eroded the effectiveness of the humble personal identification number, or “pin,” the password, etc. Although new authentication methods are being introduced, there is still physical interaction required which is exploited.

### SUMMARY OF THE INVENTION

Systems and methods for conducting neural process-based transactions are disclosed. According to one embodiment, a system for conducting a neural-based transaction may include a brainwave sensing device that detects brainwave activity for a user; a point of transaction comprising a point of transaction computer processor in communication with the brainwave sensing device; and a back end comprising a back end computer processor that is in communication with the point of transaction. The brainwave sensing device may sense brainwave activity for the user. The back end may receive the brainwave activity sensed by the brainwave sensing device, and may identify an action associated with the brainwave activity. The back end may then communicate the activity to the point of transaction, which may execute the action.

In one embodiment, the action may an authentication, a selection of a good or service, a purchase, and/or a financial transaction.

In one embodiment, the system may further include a database that stores a plurality of actions that are each associated with a unique brain activity for the user. The back end may access the database to identify the action that is associated with the brainwave sensed by the brainwave sensing device.

In one embodiment, the point of transaction may be a point of sale device, an online portal, an access restricting device for an area, etc.

In one embodiment, the back end may authenticate the user based on the brainwave sensed by the brainwave sensing device.

In one embodiment, the system may further include a biometric sensing device that receives at least one biometric from the user and communicates the biometric to the point of transaction. The point of transaction may communicate the biometric to the back end, and the back end may authenticate the user based on the brainwave sensed by the brainwave sensing device and the biometric.

In one embodiment, the brainwave sensing device may include an EEG monitoring device.

According to another embodiment, a method for conducting a neural-based transaction may include (1) receiving, at a back end for an organization, brainwave activity for a user sensed by a brainwave sensing device, wherein the back end comprises a computer processor; (2) the back end identifying an action associated with the brainwave activity sensed by the brainwave sensing device; and (3) the back end communicating the action to a point of transaction.

In one embodiment, the action may an authentication, a selection of a good or service, a purchase, and/or a financial transaction.

In one embodiment, the back end may identify the action associated with the brainwave activity received from the brainwave sensing device from a database that stores a plurality of actions that are each associated with a unique brain activity for the user.

In one embodiment, the point of transaction may be a point of sale device, an online portal, and an access restricting device for an area.

In one embodiment, the method may further include the back end authenticating the user based on the brainwave sensed by the brainwave sensing device.

In another embodiment, the method may further include the back end receiving at least one biometric from the user sensed by a biometric sensing device. The back end may authenticate the user based on the brainwave sensed by the brainwave sensing device and the biometric.

In one embodiment, the brainwave sensing device may include an EEG monitoring device.

According to another embodiment, a method of configuring a back end for a neural-based transaction is disclosed. The method may include (1) a brainwave sensing device sensing brainwave activity for a user; (2) a back end receiving the brainwave activity sensed by the brainwave sensing device; (3) the back end receiving an action to be associated with the brainwave activity sensed by the brainwave sensing device; and (4) the back end associating the action with the brainwave sensing device in a database.

In one embodiment, the brainwave sensing device may include an EEG monitoring device.

In one embodiment, the action may be an authentication, a selection of a good or service, a purchase, and/or a financial transaction.

In one embodiment, the back end may receive at least one biometric from the user and may associate the biometric with the user in a database.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for conducting neural process-based transactions according to one embodiment;

FIG. 2 depicts a method for conducting neural process-based transactions according to one embodiment;

FIG. 3 depicts a method for neural process-based transactions according to another embodiment.

### DETAILED DESCRIPTION OF PREFERRED EMBODIMENTS

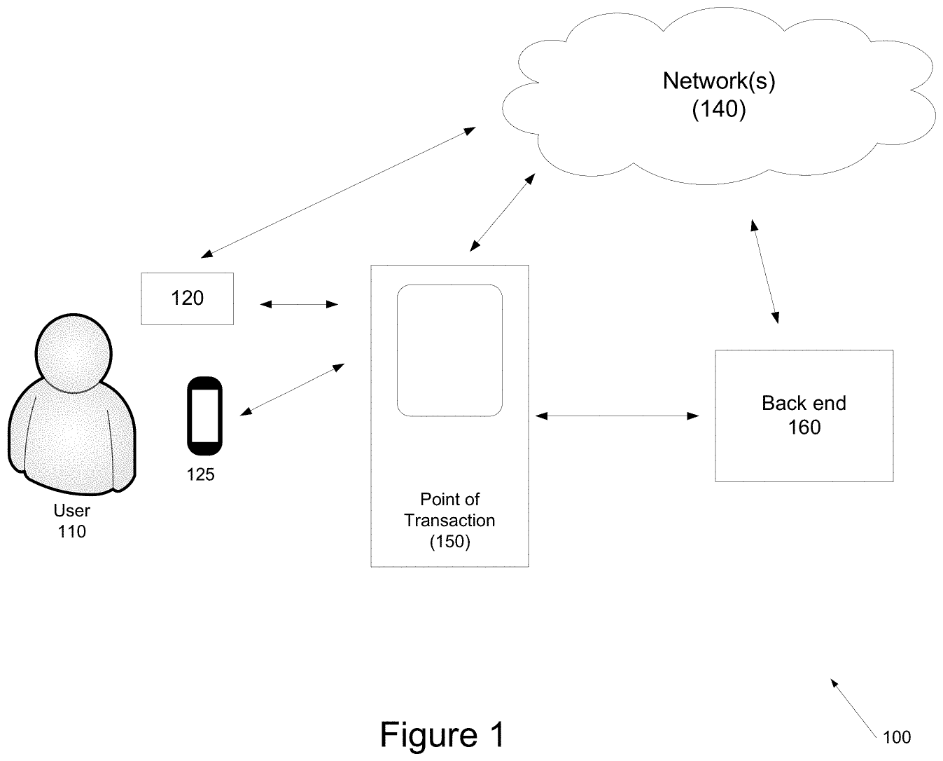

Several embodiments of the present invention and their advantages may be understood by referring to FIGS. 1-3.

Embodiments are generally directed using neural processes (e.g., brain activity) for conducting transactions.

As background, a human brain will constantly fire thousands of neurons simultaneously, generating waves at a rate of 10 to 100 cycles per second. These waves include Delta waves (under 4 Hz, occur during sleep), Theta waves (around 4-7.5 Hz, occur during sleep, deep relaxation, and visualization), Alpha Waves (7.5-13 Hz, occur in relaxed and calm states), Beta waves (14-30 Hz, occur during active thinking, problem solving, and moderate stimulation), and Gamma waves (over 30 Hz, occur during periods of high mental activity and consolidation of information). The disclosure of U.S. patent application Ser. No. 12/544,921 (U.S. Patent Application Publication No. 2010/0145215A1) is hereby incorporated, by reference, in its entirety. Additional research may indicate different wavelength ranges.

Embodiments may include brainwave frequency analysis. The user may perform “wave learning” in which the user's brainwave patterns may be learned. For example, this may be done through one or more guided sessions at a branch or kiosk, or done remotely. This may include the recitation of, or thinking of, a PIN, a passphrase, an object, a series of any of the foregoing, etc. The brainwaves may be detected using electromagnetic signal measurement. The user's thoughts may be translated into, for example, character strings that may be used as a cryptographic key, or associated with a particular word, item, and/or action.

Facial clues, such as blinking, eye rolling, nose flair, etc., and other biometrics (e.g., fingerprint, iris scan, facial recognition, head shape, etc.) may be also used alone or in conjunction with wave learning.

Referring to FIG. 1, a system for conducting neural process-based transactions is disclosed according to one embodiment. System 100 may include user 110 who may be associated with brainwave sensing device 120 and mobile electronic device 125. In one embodiment, brainwave sensing device 120 may detect user 110's brainwave patterns. Examples of suitable brainwave sensing device include the EPOC+ and the Insight EEG headsets available from EMOTIV, San Francisco, Calif.; the MindWave™ brainwave sensing headsets available from NeruoSky, San Jose, Calif.; the Intelligent Sleep Mask available from Neuroon, San Francisco, Calif.; the Brain Sensing Headband from Muse, Toronto, Canada; the Melon headband; etc.

Other suitable brainwave sensing devices, or combination of devices, may be used as necessary and/or desired.

In one embodiment, the brainwave sensing device 120 may provide information regarding the sensed brainwaves as a frequency.

In one embodiment, brainwave sensing device 120 may include additional functionality, such as a camera for capturing facial/iris biometrics, a sensor for detecting a fingerprint, a microphone for detecting voice biometrics or receiving voice instructions, buttons for interacting with the user, pressure sensors, bio-electrical impedance sensors, orientation sensors, accelerometers, oxygen sensors, heart rate sensors, etc.

In one embodiment, the functionality may be provided by more than one device. For example, brainwave sensing device 120 may sense the user's brainwave activity, a separate heart rate monitor (not shown) may detect the user's heart rate, etc.

In one embodiment, brainwave sensing device 120 may include technology to sense a pheromone indicating fear and/or duress.

In one embodiment, brainwave sensing device 120 may include one or more earpiece, speaker, etc. for providing audio to user 110, and a screen (e.g., Google Glass) for providing video output to user 110.

In one embodiment, the additional devices may communicate directly with point of transaction 150 and/or mobile electronic device 125. In another embodiment, the additional devices may communicate with point of transaction 150 and/or mobile electronic device 125 through brainwave sensing device 120. In still another embodiment, a separate device (not shown) may serve as an intermediary between the devices and point of transaction 150 and/or mobile electronic device 125. For example, each device may pair with the separate device, which may communicate the data received from the devices to point of transaction 150 and/or mobile electronic device 125.

In still another embodiment, brainwave sensing device 120 may communicate with network 140 directly.

In one embodiment, the device(s) may communicate using wires, optical communication (e.g., IR), RF communication (e.g., Bluetooth, NFC, etc.).

Mobile electronic device 125 may be any suitable device, including smartphones, tablet computers, notebook computers, Internet of Things (“IOT”) devices, etc.

System 100 may further include point of transaction 150, which may be a kiosk, a point of sale device, a merchant online presence on a computer, an ATM, an access device for a secure area (physical and electronic), an interface for a computer, etc.

In one embodiment, brainwave sensing device and/or mobile electronic device 125 may interact with point of transaction 150. In one embodiment, brainwave sensing device 120 may interact directly with point of transaction 150; in another embodiment, brainwave sensing device 120 may interact with point of transaction 150 via mobile electronic device 125.

In one embodiment, point of transaction 150 may communicate with network(s) 140, which may be any suitable communication or payment network. It may also communicate with one or more back end 160, which may process brainwave readings from brainwave sensing device 120. Back end 160 may further conduct the transaction received by point of transaction 150.

In one embodiment, point of transaction 150 and/or backend 160 may further perform additional security functions, such as receiving and processing biometric information that may be received by brainwave sensing device 120, mobile electronic device 125, and/or point of transaction 150. Examples of biometric information that may be received include fingerprint data, iris data, face shape data, voice data, etc.

In one embodiment, point of transaction 150 and/or backend 160 may authenticate the identity of user 110 based on the data received from brainwave sensing device 120, mobile electronic device 125, and/or point of transaction 150.

In another embodiment, point of transaction 150 and/or backend 160 may terminate an authenticated session if brainwave sensing device 120 is removed from user 110, if it senses the user is under duress, if it senses an emergency signal, etc.

In one embodiment, in order to conduct a transaction, point of transaction 150 and/or backend 160 may require a minimal cognitive performance from the user.

In one embodiment, point of transaction 150 and/or backend 160 may terminate a session if it detects risky or criminal behavior.

In one embodiment, brainwave sensing device 120 may incorporate noise and/or isolation functionality. For example, brainwave sensing device may include earplugs and/or eyeshades, may produce white noise, may include noise-cancelling functionality, etc. in order to focus the user's thoughts.

In one embodiment, a transaction session may be abandoned using a “SOS” message. For example, a session may be ended when a disruption is detected, such as removing brainwave sensing device 120 from user 110's person, pressing a button on brainwave sensing device 120 or point of transaction 150, by thinking a SOS term or phrase, etc. For example, as part of the training process, user 110 may think of a term or phrase and designate that term or phrase as the SOS phrase.

In another embodiment, also during learning, user 110 may be subjected to an environment that elicits duress from the user, and the brainwave patterns may be detected by brainwave sensing device 120 and stored as an indication of duress.

In one embodiment, if the SOS message, duress, or a similar thought detected by brainwave sensing device 120, point of transaction 150, and/or back end 160, point of transaction 150, and/or back end 160 may summon authorities (e.g., security, police, etc.) or may implement a “stalling” tactic to wait for help and protect user 110. For example, it may simulate an actual transaction (e.g., withdraw of money) but delay the process; may issue marked currency; may issue a silent alarm, etc. Other suitable responses may be used as necessary and/or desired.

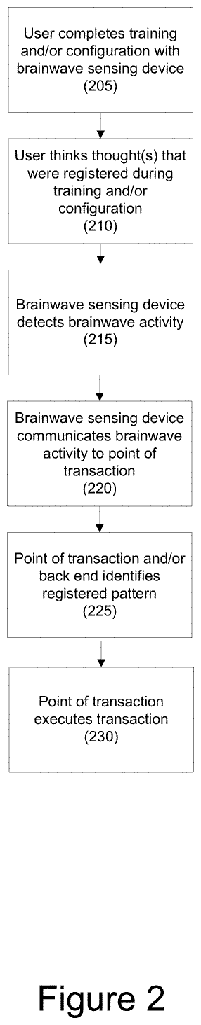

Referring to FIG. 2, a method for conducting neural process-based transactions is disclosed according to one embodiment.

In step 205, a user may perform training and/or configuration using the brainwave sensing device. In one embodiment, the user may register or associate brainwave patterns associated with a thought or series of thoughts (e.g., words, things, colors, instructions, numbers, letters, people, animals, images, etc.), and the brainwave sensing device may detect the brainwave patterns associated with those thoughts. Any thought that may be detected and registered may be used. The user may also be subjected to certain conditions to stimulate a specific response from the user, such as duress, calmness, etc. In one embodiment, the user may be subject to conditions that may be used to determine the user's minimum cognitive ability.

In one embodiment, the user may train or configure the brainwave sensing device over a period of time so that the brainwave sensing device may sense the user's normal brainwave activity.

In one embodiment, the registered pattern may be associated with a transaction. In one embodiment, the registered pattern may be associated with the transaction, such as the thought “Transfer $100 to my checking account” may be associated with that transaction. The thought, however, may not be associated with the transaction, such as the thought “green eggs and ham” may be associated with withdrawing $20 from an ATM.

In one embodiment, multiple thoughts may be used to specify things like a desired action, an account, an amount, etc., or a sequence of actions, accounts, etc.

After registration, the user may conduct a transaction using neural processes. As used herein, a transaction may involve any one or more of authentication of the user's identity, conducting a financial transaction, purchasing a good or service, accessing a secure area (physical and electronic), logging on to a computer, etc. Any suitable transaction that may involve the user's neural processes may be conducted as is necessary and/or desired.

In step 210, the user may interact with a point of transaction, such as a kiosk, a point of sale device, a merchant online presence on a computer, an ATM, an access device for a secure area (physical and electronic), an interface for a computer, etc., and may think one or more thoughts that have been registered during or after training and/or configuration. In one embodiment, the thought may comprise words, things, colors, instructions, numbers, letters, people, animals, images, etc.

In step 215, the brainwave sensing device may detect brainwave activity associated with the thought. In one embodiment, if trained, the brainwave sensing device may detect one or more pattern(s) associated with the brainwave activity.

In step 220, the brainwave sensing device may communicate the detected brainwave activity or the identified pattern(s) to the point of transaction.

In step 225, if not identified by the brainwave sensing device, the point of transaction or a back end may identify one or more registered pattern(s) for the brainwave activity.

In step 230, if the brainwave activity is associated with one or more registered pattern(s), the point of transaction may conduct the transaction. In one embodiment, the transaction may be a first part of a multi-part transaction. For example, the first transaction may be to authenticate the user's identity, and the second transaction may be to conduct a financial transaction, make a purchase, etc.

In one embodiment, the brainwave sensing device, the point of transaction, and/or back end may require a minimum amount of cognitive ability before executing the transaction. For example, the point of transaction, and/or back end may not conduct the transaction if only Delta waves or Theta waves are detected. In one embodiment, the point of transaction may attempt to get the user to a higher degree of alertness in response to detecting a low level of cognitive activity. In one embodiment, if the user does not respond adequately, the authentication and/or transaction may be denied.

In one embodiment, if the registered pattern is associated with the SOS message, duress, etc. the brainwave sensing device, the point of transaction, and/or back end may summon authorities (e.g., security, police, etc.) or may implement a “stalling” tactic to wait for help and protect the user.

In one embodiment, additional user data may be collected by the brainwave sensing device, the point of transaction, and/or the user's mobile electronic device. For example, user biometric data, usernames, passwords, PINs, responses to out-of-wallet questions (e.g., answers that are easily recallable by the user but obscure to most other persons), etc. may be collected as is necessary and/or desired.

In one embodiment, the type and/or amount of additional information may depend on the value and/or type of transaction (e.g., above a certain dollar amount), a required security level, the confidence in the brainwave authentication, etc.

In one embodiment, additional authentication may be provided using the geolocation of the brainwave sensing device and/or the user's mobile electronic device. For example, if the brainwave sensing device and/or the user's mobile electronic device are not at the same location at which a transaction is being conducted, the transaction may be denied.

In one embodiment, the user may communicate with the point of transaction solely using brainwave activity. The user may receive feedback from the point of transaction by audible, visual and/or tactile (e.g., touch through a touchpad, electronic glove and/or handset such as one provided with a virtual reality device, etc.) cues.

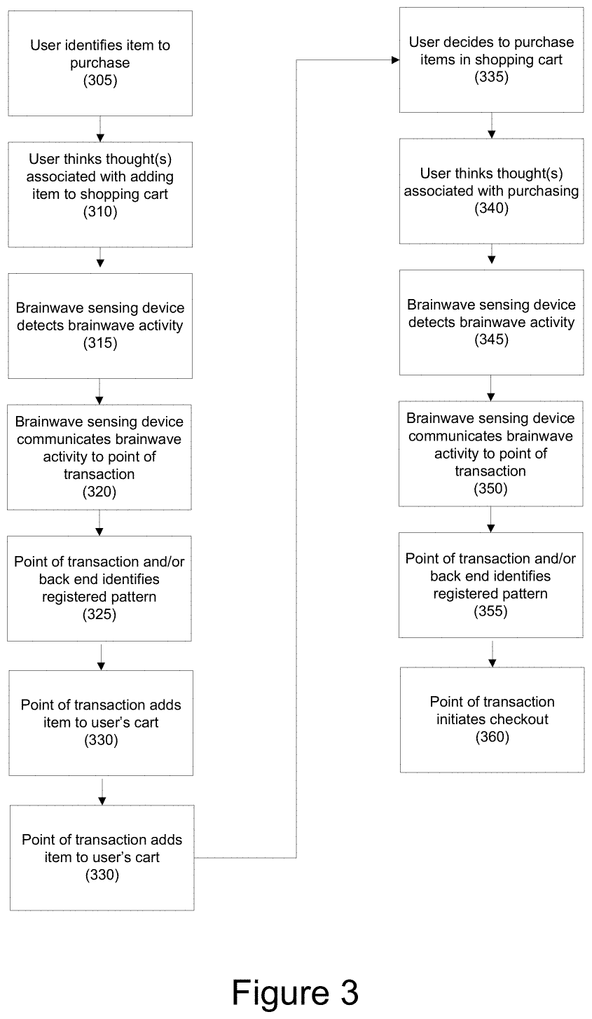

Referring to FIG. 3, a method for neural process-based transactions is disclosed according to another embodiment. The method of FIG. 3 presupposes that the user has registered one or more brainwave pattern(s) as discussed above.

In step 305, a user may identify an item to purchase. In one embodiment, the user may identify the item using an application executed by a mobile electronic device (e.g., scanning a barcode, taking an image of the item, selecting the item, etc.); looking at the item using, for example, Google Glass, browsing for the item on-line, etc.

Examples of such shopping are disclosed in U.S. patent Ser. No. 15/186,934, the disclosure of which is incorporated, by reference in its entirety.

In one embodiment, the user may pair the brainwave detecting device and/or the user's mobile electronic device to the point of transaction, or the brainwave detecting device to the point of transaction via the mobile electronic device. Examples of such are disclosed in U.S. patent Ser. No. 15/186,885, the disclosure of which is incorporated, by reference in its entirety.

In step 310, the user may think a thought, or a series of thoughts that are registered to the process of adding an item to a shopping cart. Any thought that has been registered as a purchase pattern may be used as necessary and/or desired.

In step 315, the brainwave sensing device may detect brainwave activity, in step 320, the brainwave sensing device may communicate the brainwave activity to a point of transaction, and, in step 325, the point of transaction and/or the backend may identify the registered pattern. These steps may be similar to steps 215, 220, and 225, above.

In step 330, if the pattern is identified as adding an item to a shopping cart, the point of transaction may add the item to the user's shopping cart. In one embodiment, the shopping cart may be an on-line shopping cart. In another embodiment, the shopping cart may be a virtual representation of a physical shopping cart that the user may be using.

The user may continue to shop until he or she decides to check out.

In step 335, the user may decide to check out and purchase the items in his or her shopping cart.

In step 340, the user may think a thought that is registered to purchasing an item in a shopping cart. Any thought that has been registered as a purchase pattern may be used as necessary and/or desired.

In step 345, the brainwave sensing device may detect brainwave activity, in step 350, the brainwave sensing device may communicate the brainwave activity to a point of transaction, and, in step 355, the point of transaction and/or the back end may identify the registered pattern. These steps may be similar to steps 215, 220, and 225, above.

In step 355, if the pattern is identified as purchasing the items in the shopping cart, the point of transaction may begin the checkout process. The process may be similar to that described above with regard to step 230.

Although several embodiments have been disclosed, it should be recognized that these embodiments are not exclusive to each other.

The following disclosures are hereby incorporated, by reference, in their entireties: U.S. Pat. Nos. 7,689,272; 9,332,013; 9,319,388; 8,065,529; 7,594,122; 9,058,473; 8,028,896; and 7,117,365; U. S Patent Application Publication Nos. 2013/0317382; 2013/0317384; 2016/0029958; 2016/0029959; 2015/0172827; 2015/03389171; and 2011/0162067; and U.S. patent application Ser. Nos. 14/189,608; 13/908,618; 13/492,126; 13/297,475; 11/337,563, 12/534,167; 10/867,103; 12/715,520; 10/710,315; 10/710,328; 11/294,785; U.S. Provisional Patent Application Ser. Nos. 61/820,917 and 61/823,669.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, OSI, Bluetooth LE, ZigBee, NFC, 6LowPan, Z-wave, etc.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

Other examples of user interfaces include EEG monitoring device, biometric input devices, etc.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A system for conducting a neural-based transaction, comprising:
a brainwave sensing device that detects brainwave activity for a user;
a point of transaction comprising a point of transaction computer processor in communication with the brainwave sensing device;
a back end comprising a back end computer processor that is in communication with the point of transaction;
wherein:
the brainwave sensing device senses brainwave activity for the user;
the back end receives the brainwave activity sensed by the brainwave sensing device;
the back end identifies a registered user action associated with the brainwave activity sensed by the brainwave sensing device;
the back end communicates the registered user action to the point of transaction; and
the point of transaction executes the registered user action.

2. The system of claim 1, wherein the registered user action comprises at least one of an authentication, a selection of a good or service, a purchase, and a financial transaction.

3. The system of claim 1, further comprising a database comprising a plurality of registered user actions that are each associated with a unique brain activity for the user, and the back end accesses the database to identify the registered user action that is associated with the brainwave sensed by the brainwave sensing device.

4. The system of claim 1, wherein the point of transaction comprises a point of sale device.

5. The system of claim 1, wherein the point of transaction comprises an online portal.

6. The system of claim 1, wherein the point of transaction comprises an access restricting device for an area.

7. The system of claim 1, wherein the back end authenticates the user based on the brainwave sensed by the brainwave sensing device.

8. The system of claim 1, further comprising:
a biometric sensing device that receives at least one biometric from the user and communicates the biometric to the point of transaction;
wherein the point of transaction communicates the biometric to the back end; and
the back end authenticates the user based on the brainwave sensed by the brainwave sensing device and the biometric.

9. The system of claim 1, wherein the brainwave sensing device comprises an EEG monitoring device.

10. A method for conducting a neural-based transaction, comprising:
receiving, at a back end for an organization, brainwave activity for a user sensed by a brainwave sensing device, wherein the back end comprises a computer processor;
the back end identifying a registered user action associated with the brainwave activity sensed by the brainwave sensing device; and
the back end communicating the registered user action to a point of transaction.

11. The method of claim 10, wherein the registered user action comprises at least one of an authentication, a selection of a good or service, a purchase, and a financial transaction.

12. The method of claim 10, wherein the back end identifies the registered user action associated with the brainwave activity received from the brainwave sensing device from a database comprising a plurality of registered user actions that are each associated with a unique brain activity for the user.

13. The method of claim 10, wherein the point of transaction comprises one of a point of sale device, an online portal, and an access restricting device for an area.

14. The method of claim 10, further comprising:
the back end authenticating the user based on the brainwave sensed by the brainwave sensing device.

15. The method of claim 10, further comprising:
the back end receiving at least one biometric from the user sensed by a biometric sensing device; and
wherein the back end authenticates the user based on the brainwave sensed by the brainwave sensing device and the biometric.

16. The method of claim 10, wherein the brainwave sensing device comprises an EEG monitoring device.

17. A method of configuring a back end for a neural-based transaction, comprising:
a brainwave sensing device sensing brainwave activity for a user;
a back end receiving the brainwave activity sensed by the brainwave sensing device;
the back end receiving a registered user action to be associated with the brainwave activity sensed by the brainwave sensing device; and
the back end associating the registered user action with the brainwave sensing device in a database.

18. The method of claim 17, wherein the brainwave sensing device comprises an EEG monitoring device.

19. The method of claim 17, wherein the registered user action comprises at least one of an authentication, a selection of a good or service, a purchase, and a financial transaction.

20. The method of claim 17, further comprising:
the back end receiving at least one biometric from the user; and
the back end associating the biometric with the user in a database.
